(19) United States
(12) Patent Application Publication
(10) Pub. No.: US 2025/0229576 A1
(43) Pub. Date: Jul. 17, 2025

(54) PNEUMATIC TIRE

(71) Applicant: Toyo Tire Corporation, Itami-shi (JP)

(72) Inventor: Yoshiki Sato, Itami-shi (JP)

(73) Assignee: Toyo Tire Corporation, Itami-shi (JP)

(21) Appl. No.: 19/004,744

(22) Filed: Dec. 30, 2024

(30) Foreign Application Priority Data
Jan. 11, 2024 (JP) 2024-002257

(51) Int. Cl. B60C 13/02

(52) U.S. Cl. CPC B60C 13/02

(57) ABSTRACT

A pneumatic tire that is an example of an embodiment includes a tread and a sidewall, and the sidewall has at least one side block. At an inner end of the side block in a tire radial direction, a protrusion is formed that protrudes outward in a tire axial direction. A height H2 of the protrusion is, for example, between 1.1 and 3.0 times a height H1 of a highest portion of the side block other than the protrusion.

### CROSS REFERENCE TO RELATED APPLICATION

The entire disclosure of Japanese Patent Application No. 2024-002257 filed on Jan. 11, 2024, including the specification, claims, drawings, and abstract is incorporated herein by reference in its entirety.

### TECHNICAL FIELD

The present disclosure relates to a pneumatic tire, and more specifically to a pneumatic tire with a side block.

### BACKGROUND

In recent years, there has been a demand for tires to have reduced air resistance from the viewpoint of improving fuel efficiency and other aspects of vehicles. Conventionally, there have been widely known pneumatic tires with side blocks formed on the sidewalls in order to improve traction performance, side cut performance, and the like in off-road driving (see, for example, JP 2023-10598 A). However, the presence of side blocks makes it more difficult to reduce air resistance. In general, side blocks increase air resistance of tires.

### SUMMARY

An object of the present disclosure is to reduce air resistance in a pneumatic tire with a side block.

A pneumatic tire according to an aspect of the present disclosure is a pneumatic tire including: a tread; and a sidewall, wherein the sidewall includes at least one side block, and at least one protrusion is formed at an inner end of the side block in a tire radial direction, the protrusion protruding outward in a tire axial direction.

According to an aspect of the present disclosure, air resistance can be reduced in a pneumatic tire including a side block.

### BRIEF DESCRIPTION OF DRAWINGS

Embodiments of the present disclosure will be described based on the following figures.

FIG. 1 is a perspective view of a pneumatic tire according to a first embodiment;

FIG. 2 is a partially enlarged view of a side surface of the pneumatic tire according to the first embodiment;

FIG. 3 is a view showing part of a cross section taken along line A-A in FIG. 2;

FIG. 4 is a sectional view showing an enlarged view of a protrusion of a side block and its vicinity;

FIG. 5 is a perspective view of a pneumatic tire according to a second embodiment;

FIG. 6 is a sectional view of the pneumatic tire according to the second embodiment;

FIG. 7 is a perspective view of a pneumatic tire according to a third embodiment; and

FIG. 8 is a sectional view of the pneumatic tire according to the third embodiment.

### DESCRIPTION OF EMBODIMENTS

Hereinafter, an example of an embodiment of a pneumatic tire according to the present disclosure will be described in detail with reference to the drawings. The embodiment described below is merely an example, and the present disclosure is not limited to the following embodiment. In addition, the present disclosure includes forms that selectively combine the components of a plurality of embodiments and modified examples described below.

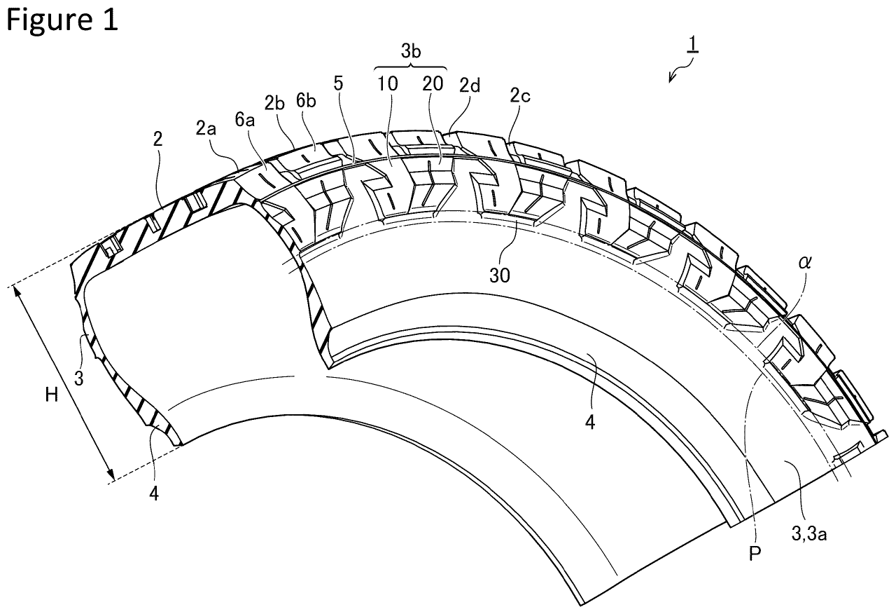

FIG. 1 is a perspective view of a pneumatic tire 1 that is an example of an embodiment. As shown in FIG. 1, the pneumatic tire 1 includes a tread 2 that is a portion in contact with the road surface, sidewalls 3 each forming a side surface of a tire, and beads 4 each being a portion fixed to a rim of a wheel. The tread 2 has a tread pattern that includes a plurality of blocks such as shoulder blocks 2a, 2b. In addition, the tread 2 is formed with a plurality of grooves 2c, 2d that divide the blocks. The tread 2, the sidewalls 3, and the beads 4 are formed in an annular shape in the tire circumferential direction.

The sidewalls 3 extend inward in the radial direction from the opposite ends of the tread 2 in the tire axial direction, and form the left and right side surfaces of the pneumatic tire 1, together with the beads 4. As will be described in detail later, a sidewall 3 has side blocks 3b protruding outward in the tire axial direction from a profile surface 3a of the sidewall 3. The side blocks 3b improve traction performance and side cut performance in off-road driving. The inner end of a side block 3b in the tire radial direction is formed with a protrusion 30 for reducing air resistance.

The pneumatic tire 1 is suitable, for example, for tires for light trucks. Light trucks include pickup trucks and sports utility vehicles (SUVs). One example of the size of the pneumatic tire 1 is LT275/60R20.

The pneumatic tire 1 has a side rib 5 formed on a tire side surface in the vicinity of the tread 2. The side rib 5 is a protruding portion that protrudes outward in the tire axial direction, and is formed in an annular shape in the tire circumferential direction. In this embodiment, a buttress region is defined as a portion from an outer end, in the tire axial direction, of the surfaces of the shoulder blocks 2a, 2b to the side rib 5, shoulder blocks 2a, 2b facing outward in the tire radial direction. Also, a sidewall 3 is defined as a portion from the bead 4 to the side rib 5. The shapes of the side surfaces 6a, 6b of the shoulder blocks 2a, 2b facing outward in the tire axial direction affect the shape of a buttress region.

The tread 2 and the sidewalls 3 are generally made of different types of rubber. The buttress region may be made of the same rubber as the tread 2, or may be made of a different rubber. Each bead 4 has, for example, a bead core and a bead filler. The bead core is a ring-shaped member made of bundled steel wires (bead wires) covered with rubber. The bead fillers are made of rubber that is harder than the tread rubber and the sidewall rubber, and have function of increasing the rigidity of the bead 4.

The pneumatic tire 1 includes, for example, a carcass, a belt, and an inner liner. The carcass is a cord layer covered with rubber, and forms the framework of the pneumatic tire 1 that can withstand loads, impacts, air pressure, etc. The belt is a reinforcing band arranged between the carcass and the rubber that constitutes the tread 2. The belt tightens the carcass to increase the rigidity of the pneumatic tire 1. The inner liner is a rubber layer provided on the inner circumferential surface of the carcass, and maintains the air pressure of the pneumatic tire 1.

FIG. 1 shows side blocks 3b on the left side of the pneumatic tire 1, and the pneumatic tire 1 preferably has side blocks 3b on both the left and right sidewalls 3. Preferably, both the left and right side blocks 3b each have a protrusion 30 formed thereon. However, the left and right side blocks 3b are not limited to being blocks of the same shape, and may be of completely different shapes. Each side block 3b on the right side surface has a shape formed by 180° rotation of the side block 3b on the left side surface with respect to a center line that passes through the tire equator and is perpendicular to the tire rotation axis. The pneumatic tire 1 may be a tire with no specified mounting direction.

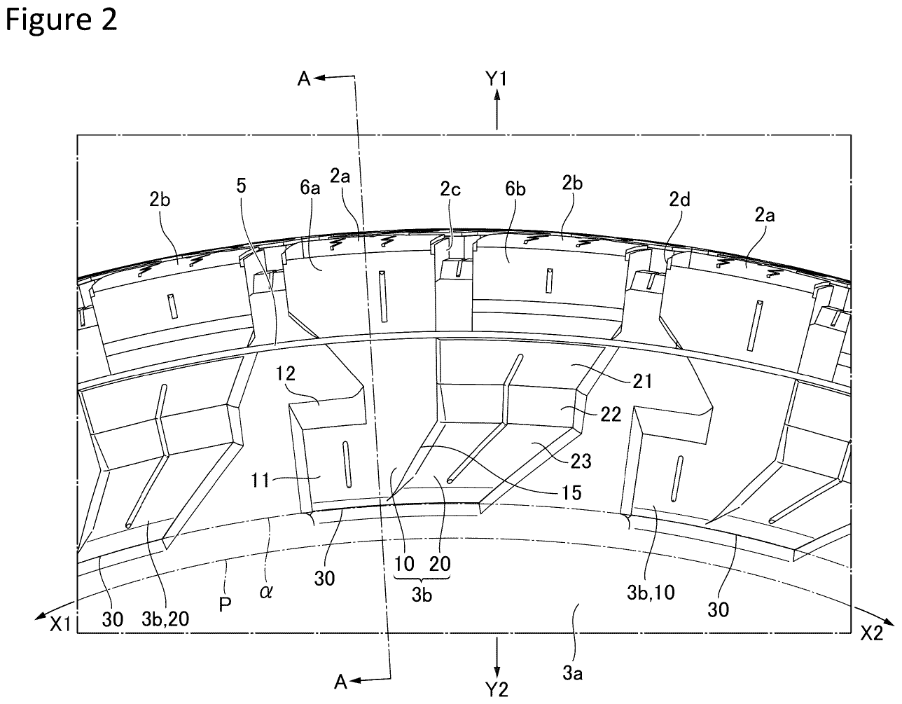

Hereinafter, the sidewall 3 and the buttress region of the pneumatic tire 1 will be described in detail with further reference to FIG. 2. FIG. 2 is a left side view of the pneumatic tire 1, showing an enlarged view of the sidewall 3 and the buttress region. In the following, a first direction in the tire circumferential direction may be referred to as an “X1 direction” and a second direction may be referred to as an “X2 direction”. The direction facing outward in the tire radial direction may be referred to as a “Y1 direction”, and the direction facing inward in the radial direction may be referred to as a “Y2 direction”.

As shown in FIG. 1 and FIG. 2, the pneumatic tire 1 has a plurality of side blocks 3b formed on a sidewall 3. The plurality of side blocks 3b are arranged at predetermined intervals in the tire circumferential direction. The predetermined intervals may be constant, or may be a variable pitch in which the intervals between the blocks and the circumferential lengths of the blocks are slightly different in units of a predetermined number of blocks. Each side block 3b includes a first side block 10 and a second side block 20. A step is formed at a boundary 15 between the first side block 10 and the second side block 20, and the first side block 10 protrudes farther outward in the tire axial direction than the second side block 20.

In this embodiment, the side blocks 3b having substantially the same shape line up in the tire circumferential direction. However, two or more types of blocks having different shapes may be arranged alternately in the tire circumferential direction or may be arranged in a predetermined pattern. The number of side blocks 3b lining up in the tire circumferential direction is not particularly limited, but as an example, it is 20 or more and 30 or less.

The side blocks 3b are preferably formed between the side rib 5 and a tire maximum width position P. This makes it easy to reduce air resistance while ensuring sufficient side traction performance and side cut (protection) performance. In the present description, the “tire maximum width position P” means a position where the length in the tire axial direction is maximum in the profile surface 3a of the sidewall 3. The “profile surface 3a” of the sidewall 3 means a surface of the sidewall 3 facing outward in the tire axial direction if the side block 3b is not formed. In the profile surface 3a, there is a virtual surface along the surface of the sidewall 3, the virtual surface being hidden by the side blocks 3b. The virtual surface is defined as a “profile surface 3x” to distinguish it from the exposed surface.

Each side block 3b is a block formed by one first side block 10 and one second side block 20 that are integrally connected. The first side block 10 and the second side block 20 have substantially the same length in the tire radial direction, and each block has its inner end in the tire radial direction that is formed with a protrusion 30 extending in the tire circumferential direction. The protrusion 30 is formed substantially parallel to the side rib 5, as will be described in detail later. The protrusions 30 realize air flow along the surface of the sidewall 3, effectively reducing air resistance in driving.

The portions located between the side blocks 3b have the same height as the profile surface 3a of the sidewall 3. As a result, the portion located between the side rib 5 and the tire maximum width position P of the sidewall 3 has unevenness in the tire circumferential direction. The unevenness improves side traction performance on muddy ground or sandy ground, or on snowy roads. From the viewpoint of improving side cut performance, the length of each side block 3b in the tire circumferential direction is preferably longer than the interval between the side blocks 3b.

The side blocks 3b and the shoulder blocks 2a, 2b of the tread 2 are preferably arranged in a regular pattern in which they are related to each other. In this case, an integrated regular pattern is formed in the sidewall 3 and the buttress region, which, for example, stabilizes side traction performance and improves the effect of reducing air resistance. In this embodiment, each first side block 10 is formed so as to line up with the shoulder block 2a in the tire radial direction, and each second side block 20 is formed so as to line up with the shoulder block 2b in the tire radial direction.

The shoulder blocks 2a, 2b are blocks formed on an outer portion of the tread 2 in the tire axial direction, and are arranged alternately in the tire circumferential direction. A shoulder block 2a and a shoulder block 2b, for example, have a similar size, but differ in shape in that the side surface 6b of the shoulder block 2b is recessed more than the side surface 6a of the shoulder block 2a. The side surface 6b of the shoulder block 2b has a step formed over the entire length of the side surface 6b in the tire circumferential direction, and has a block surface side recessed more than the side rib 5 side.

The shoulder blocks 2a, 2b are separated by grooves 2c, 2d extending in the tire axial direction. Each groove 2c is formed with substantially the same width from a portion between the blocks to the side rib 5, while each groove 2d is widened in the vicinity of the side rib 5. The side surfaces 6a, 6b of the shoulder blocks 2a, 2b, and the grooves 2c, 2d form unevenness in the tire circumferential direction in the buttress region of the pneumatic tire 1. Like the side blocks 3b, the unevenness improves side traction performance on muddy ground, sandy ground, or snowy roads.

Each side block 3b is formed in an area that overlaps with the shoulder blocks 2a, 2b and the groove 2c in the tire radial direction, but are not formed in a portion that overlaps with groove 2d in the tire radial direction. In other words, the side blocks 3b are formed at the same pitch as the pair of shoulder blocks 2a, 2b in the tire circumferential direction. Each interval between the side blocks 3b is wider on the tire maximum width position P side than on the side rib 5 side. In this case, for example, mud discharge performance is improved and side traction performance is improved on muddy ground.

Each first side block 10 constituting the side block 3b is sandwiched between two second side blocks 20, but is continuous with one second side block 20 and is not connected to the other second side block 20. The first side block 10 is formed in an area that overlaps with the shoulder block 2a in the tire radial direction, and the second side block 20 is formed in an area that overlaps with the shoulder block 2b and groove 2c in the tire radial direction. The second side block 20 is larger than the first side block 10, and part of it extends to a position that overlaps with the shoulder block 2a in the tire radial direction. Note that in this embodiment, the second side block 20 overlaps the groove 2c in the tire radial direction, but the first side block 10 may overlap the groove 2c in the tire radial direction.

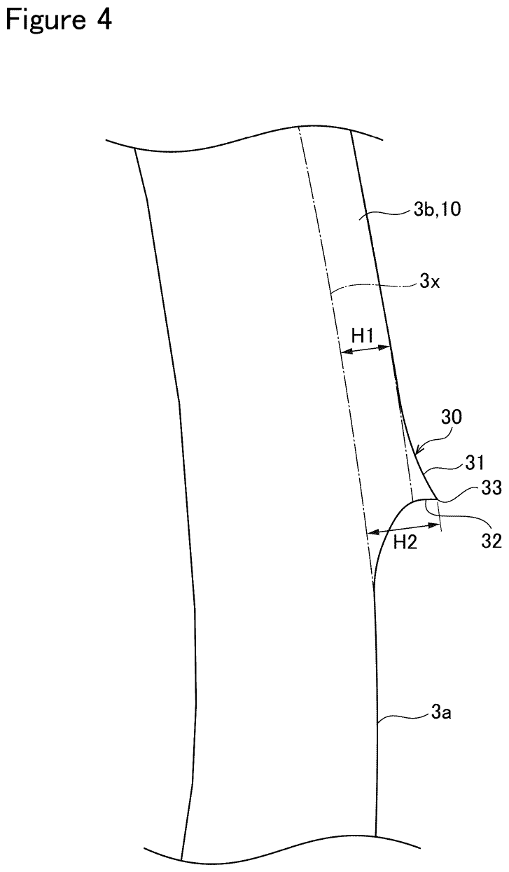

As described above, the first side block 10 has a different height from the second side block 20, in which the first side block 10 is formed higher. The height H1 of the side block 3b (see FIG. 4 described later) means the length, in the normal direction of the profile surface 3x, from the profile surface 3x of the sidewall 3 to the surface of the side block 3b. There is a difference in height between the two blocks that constitute the side block 3b, and there is a difference in height between the side block 3b and the gap between the side blocks 3b. The differences form unevenness in the sidewall 3, and the unevenness improves the side traction performance on muddy ground, sandy ground, or snowy roads.

Each first side block 10 has a substantially constant height, for example, except for the protrusion 30 at the inner end in the tire radial direction and the block ends. In contrast, the second side block 20 has three regions (a first region 21, a second region 22, and a third region 23) with different heights in the tire radial direction. The height of the second side block 20 is substantially constant in the first region 21 adjacent to the side rib 5, and is lowest at the boundary between the second region 22 and the third region 23. The protrusions 30 are formed at the same height in the first side block 10 and the second side block 20.

Each first side block 10 has a shape in which the portion located on the inner side in the tire radial direction projects in the X1 direction, i.e., in the opposite direction to the continuous second side block 20. This projection 11 is formed, for example, in a length range of 30% to 70% of the length of the first side block 10 in the tire radial direction from the inner end in the tire radial direction (Y2 direction end). In other words, the first side block 10 has a shape in which the portion, located on the outer side in the tire radial direction (Y1 direction side) close to the side rib 5, is recessed in the X2 direction. Such unevenness of the first side block 10 contributes to improving side traction performance. The X1 direction end of the projection 11 is formed in a substantially straight line in a side view in the tire radial direction.

The block ends of each side block 3b may be formed perpendicular to the profile surface 3a, or may be inclined so that the height of the block gradually decreases. There is formed an inclined surface 12 that is more gently inclined than the other block ends, at an end of the projection 11 of the first side block 10. The inclined surface 12 is located at the block end facing the Y1 direction. Forming the gentle inclined surface 12 at the Y1 direction end of the projection 11 can cause air to be more likely to flow along the surface of the sidewall 3, preventing increase in air resistance. The inclination angle of the inclined surface 12 with respect to the profile surface 3x is, for example, 40° or more and 750 or less.

The boundary 15 between the two blocks, which constitute each side block 3b, extends from the side rib 5 in the tire radial direction and bends in the X1 direction at center of the block. As a result, the portion located on the Y2 direction side of the first side block 10 gradually decreases in length in the tire circumferential direction progressing in the Y2 direction. Note that the first side block 10 and the second side block 20 have different heights, so a step is formed along the boundary 15.

As described above, each second side block 20 has a different height in the tire radial direction, and has the first region 21, adjacent to the side rib 5, that is highest in the portions other than the protrusion 30. The second region 22 adjacent to the first region 21 in the Y2 direction is inclined so that its height gradually decreases progressing in the Y2 direction. The third region 23 adjacent to the second region 22 in the Y2 direction is inclined so that its height gradually increases progressing in the Y2 direction. The gentle inclinations provided on the surface of the second side block 20 can cause air flow to be more likely to be generated along the surfaces of the second side block 20, preventing increase in air resistance.

Each second side block 20 is inclined with respect to the tire radial direction so that the block end facing the X2 direction gradually shifts in the X1 direction progressing in the Y2 direction. The second side block 20 has a tapered shape in which the tire circumferential length is slightly shorter at the Y2 direction end than at the Y1 direction end.

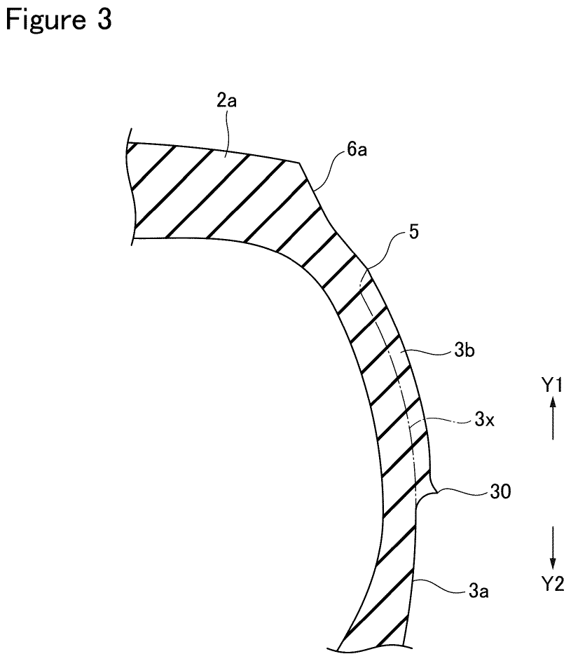

The protrusions 30 of the side blocks 3b will be described in more detail below with reference to FIGS. 2 to 4. FIG. 3 is a diagram showing part of the cross section taken along a line A-A in FIG. 2. FIG. 4 is a sectional view of each protrusion 30 and its vicinity.

As shown in FIGS. 2 to 4, each protrusion 30 that protrudes outward in the tire axial direction is formed at the inner end of the side block 3b in the tire radial direction (Y2 direction end), as described above. The protrusion 30 protrudes more than other portions of the side block 3b. The study of the present inventors has found that air resistance of the tire can be effectively reduced by preventing convection and vortexes occurring in the vicinity of the sidewall 3 and by creating air flow along the surface of the sidewall 3. Providing the protrusion 30 at the Y2 direction end of the side block 3b has successfully achieved a smooth airflow along the surface of the sidewall 3.

Each protrusion 30 just needs be formed at the Y2 direction end of the side block 3b, but is preferably formed within a length range equivalent to 20% of the tire cross-sectional height H (see FIG. 1) from the tire maximum width position P. In this case, the effect of providing the protrusion 30 is more noticeable. In particular, the protrusion 30 is formed preferably at the tire maximum width position P or on the tread 2 side with respect to the maximum width position P. In this embodiment, the protrusion 30 is formed on the tread 2 side with respect to the tire maximum width position P and in the vicinity of the tire maximum width position P. The tire rotates at high speed when the vehicle is being driven. Therefore, it is considered that grooves in the radial direction do not affect air resistance much, and it is important to create air flow along the surface of the sidewall 3 in order to reduce air resistance, as described above.

Each protrusion 30 is preferably located within a length range equivalent to 10% or 5% of the tire cross-sectional height H in the Y1 direction from the tire maximum width position P. Since the protrusion 30 is formed at the Y2 direction end of each side block 3b, the Y2 direction end of the block needs to be located within this length range. The extremity 33 of the protrusion 30 is located within a length range in the Y1 direction from the tire maximum width position P, the length range being, for example, equivalent to 5% of the tire cross-sectional height H. The extremity 33 is the portion highest in the protrusion 30.

The height H2 of each protrusion 30 is preferably between 1.1 and 3.0 times the height H1 of the portion that is highest in the side block 3b other than the protrusion 30. In this case, the effect of reducing air resistance by providing the protrusion 30 is more noticeable. In this embodiment, the portion of the side block 3b with the highest height other than the protrusion 30 is the surface of the first side block 10. The height H2 of the protrusion 30 means the length, in the normal direction of the profile surface 3x, from the profile surface 3x to the highest portion of the protrusion 30 (extremity 33). The same applies to the height H1.

The height H2 of each protrusion 30 is more preferably between 1.1 and 2.5 times the height H1, particularly preferably between 1.3 and 2.0 times, and most preferably between 1.4 and 1.9 times. An example of the height H1 of the side block 3b is 1 mm or more and 15 mm or less, 2 mm or more and 10 mm or less, or 3 mm or more and 5 mm or less. If the height of the protrusion 30 is within this range, the effect of reducing air resistance is more noticeable. If the height H2 of the protrusion 30 is too low, the effect of the protrusion 30 is small, and if the height H2 is too high, air resistance may increase. The height H2 of the protrusion 30 is, for example, 2 mm or more and 18 mm or less, 3 mm or more and 17 mm or less, or 5 mm or more and 15 mm or less.

Each protrusion 30 may be formed on only one of the first side block 10 or the second side block 20, but is preferably formed on both of the blocks. As described above, the lengths of the first side blocks 10 and the second side blocks 20 are constant in the tire radial direction, so protrusions 30 of the blocks are arranged in the tire circumferential direction. In other words, each protrusion 30 is formed in a gently curved line in a side view of the pneumatic tire 1. This is likely to provide an airflow along the surface of the sidewall 3, and to improve the effect of reducing air resistance.

The heights H2 of protrusions 30 may be different in the first side block 10 and the second side block 20, but they are preferably substantially the same height. Making the heights H2 of the protrusions 30 constant can provide a stable effect of reducing air resistance. The portion of each second side block 20 other than the protrusion 30 has a lower height than the first side block 10. Therefore, the second side block 20 has a larger height difference between the protrusion 30 and the other portion than the first side block 10. Note that the surface of the second side block 20 is formed with the gentle inclined surfaces in the tire radial direction, so airflow is likely to occur along the block surface.

The protrusions 30 are preferably formed on all side blocks 3b (the first side blocks 10 and the second side blocks 20). Preferably, a plurality of protrusions 30 are formed on the circumference of the same circle α in the tire circumferential direction. In other words, the plurality of protrusions 30 are formed intermittently in the tire circumferential direction, and the protrusions 30 line up in a row in the tire circumferential direction. In this case, the effect of reducing air resistance by providing the protrusions 30 is more noticeable. In this embodiment, the plurality of protrusions 30 are arranged parallel to the side rib 5 and are constant in length, width, and height. Note that the circle α is a perfect circle centered on the rotation axis of the pneumatic tire 1.

The total length of the protrusions 30 in the tire circumferential direction is preferably 30% or more of the circumferential length of the circle α, more preferably 40% or more, and particularly preferably 50% or more. In this case, the effect of reducing air resistance by providing the protrusions 30 is more noticeable. The protrusions 30 may be formed in an annular shape in the tire circumferential direction. However, in this case, at least the Y2 direction ends of side blocks 3b are continuous in the tire circumferential direction. This requires that the side blocks 3b each have a block shape that does not decrease the side traction performance. The total length of the protrusions 30 in the tire circumferential direction may exceed 50% of the circumferential length of the circle α, and may be, for example, more than 50% and 70% or less.

Each protrusion 30 includes a first inclined surface 31 formed between the surface of the side block 3b and the extremity 33 of the protrusion 30, and a second inclined surface 32 formed between the profile surface 3a and the extremity 33 of the protrusion 30. Preferably, the first inclined surface 31 has a gentler inclination than the second inclined surface 32, and has a smaller inclination angle with respect to the profile surface 3x. This makes it easy to achieve both sufficient side traction performance and low air resistance. The extremity 33 of the protrusion 30 may be sharp, as shown in FIG. 4, or may be slightly curved so that the corner is chamfered.

The first inclined surface 31 of each protrusion 30 may be a straight inclined surface without any unevenness, or may be a gently curved inclined surface that is convex in the Y2 direction. In addition, the inclination angle of the first inclined surface 31 may gradually increase progressing toward the extremity 33. In any case, the inclined surface preferably has an inclination angle with respect to the profile surface 3x that satisfies the first inclined surface 31<the second inclined surface 32, for both the maximum value and the average value. At the Y2 direction end of the side block 3b, the position where the height of the side block 3b starts to increase, as viewed from the Y1 direction, is defined as the starting point of the first inclined surface 31. Note that the second inclined surface 32 is an inclined surface that is continuous with the inclined surface at the block end, and the boundary position with the inclined surface at the block end does not have to be clear.

Like the first inclined surface 31, the second inclined surface 32 of each protrusion 30 may be a straight inclined surface without any unevenness, or may be a curved inclined surface that is convex in the Y1 direction. The inclination angle of the second inclined surface 32 may gradually increase progressing toward the extremity 33, and at least part of the second inclined surface 32 may be formed substantially perpendicular to the profile surface 3x. In this embodiment, the second inclined surface 32 is a curved surface that is continuous with the inclined surface at the block end. The inclination of the first inclined surface 31 affects air resistance, so it is preferably gentle. However, the inclination of the second inclined surface 32 is considered to have almost no influence on air resistance, so making the inclination steeper can improve traction performance.

A simulation has been performed to analyze air flow around the rotating pneumatic tires 1 having the above-described configuration. In this simulation, the height H1 of the side block 3b and the height H2 of the protrusion 30 has been changed, and the air resistance has been evaluated by the following method. In addition, the traction performance has been evaluated by a single wheel traction test on muddy and sandy ground. The evaluation results are shown in Table 1. The evaluation results shown in Table 1 are relative values, which means that as the numerical value increases, the air resistance decreases and the traction performance increases.

### [Evaluation of Air Resistance]

For each test tire, the drag has been measured, the drag meaning the force that acts on a tire placed in an air flow and that acts parallel to the flow and in the same direction as the flow. The drag coefficient Cd has been calculated from the following expression. The drag has been determined from the pressure difference between the front and the rear of the tire obtained by simulation.

$$Cd = D / ( 1 / 2 ρ U 2 S )$$

where: D is the generated drag; p is the air density, which is set to 1.18415 [kg/m³]; U is the representative speed that is the relative speed between the tire and the air, which is set to 36.1 [m/s]; and S is the representative area (frontal projected area) of the tire.

### [Evaluation of Traction Performance]

The traction performance of each test tire has been evaluated on muddy and sandy ground based on the single wheel traction test “ASTM F1805” used in snow traction evaluation. This test determines the front-rear force (Fx) and perpendicular load (Fz) of each test tire, and gives the forward traction index (μ=Fx/Fz). The traction index (μ) of each test tire indicates the friction characteristics of the tire on the road surface on which the test was performed, and is calculated as a relative value with respect to the numerical value of the reference tire. This means that as the numerical value increases, the traction performance increases.

This test is performed by mounting each test tire on one test wheel of a test vehicle and mounting the reference tire on another test wheel thereof, and driving the vehicle on a test course. The evaluation is also performed based on the following standards.
ASTM F1805
ASTM F377
ASTM D2487
ASTM D4318

The load and air pressure on each tire are those having values applied to light truck tires. Specifically, the test load is set to 567 kgf and the air pressure is set to 345 kPa.

TABLE 1

| No. | 1 | 2 | 3 | 4 | 5 |
|---|---|---|---|---|---|
| H1 (mm) | 0.5 | 3 | 3 | 10 | 20 |
| H2 (mm) | 2 | 5 | 10 | 15 | 20 |
| H2/H1 | 4.0 | 1.7 | 3.3 | 1.5 | 1.0 |
| Air Resistance | 80 | 110 | 95 | 107 | 90 |
| Index | | | | | |
| traction Index | 90 | 105 | 105 | 110 | 120 |

Table 1 shows that H2/H1 of 1.1 or more and 3.0 or less makes it possible to effectively reduce the air resistance while ensuring high side traction performance. H2/H1 of 1.0 and absence of protrusions 30, as in No. 5, cannot provide the effect of reducing air resistance. Also, H2/H1 exceeding 3.0, as in No. 1 and 4, cannot provide the effect of reducing air resistance. H2/H1 of 1.4 or more and 1.9 or less, or 1.6 or more and 1.8 or less provides a particularly noticeable effect of reducing air resistance.

As described above, the pneumatic tire 1 having the above configuration can effectively reduce air resistance in a tire including side blocks 3b. The protrusions 30 formed on the inner ends of the side blocks 3b in the tire radial direction can create an air flow that flows along the surface of the sidewall 3, thereby significantly reducing air resistance. Furthermore, the pneumatic tire 1 can prevent increase in air resistance even if large side blocks 3b are provided.

The pneumatic tire 1 can ensure side traction performance and side cut performance that are the same as or higher than conventional ones while reducing air resistance. The pneumatic tire 1 is particularly suitable for tires for light trucks.

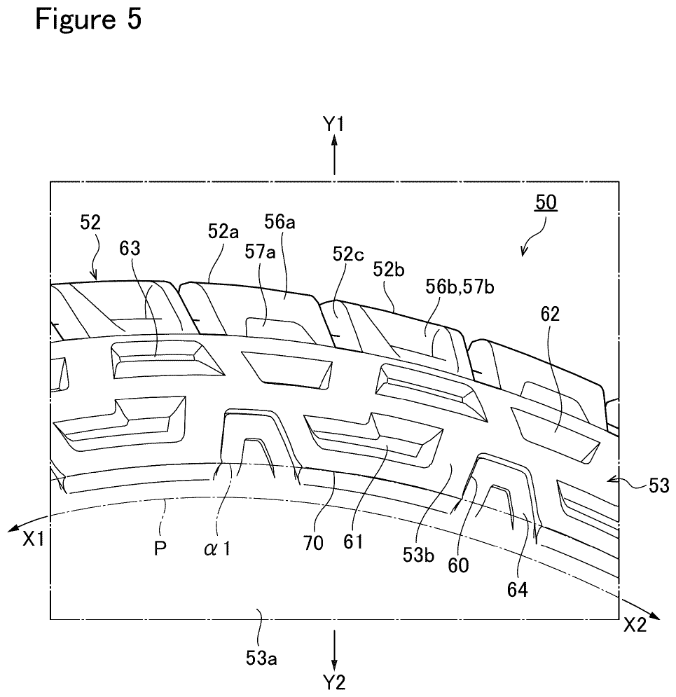

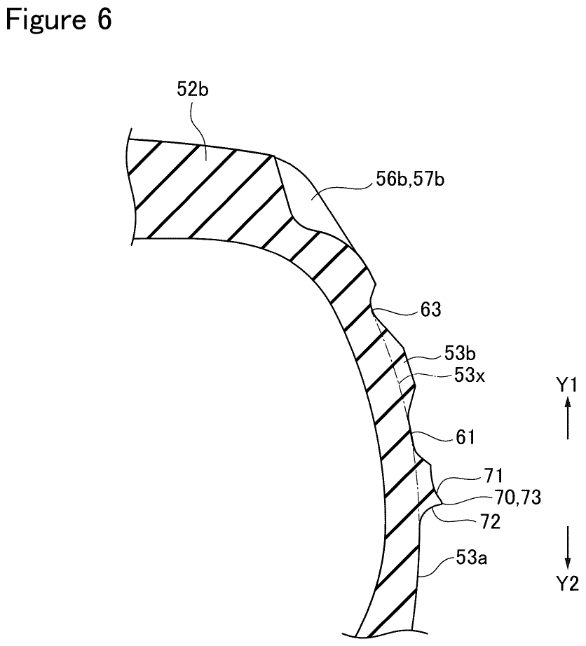

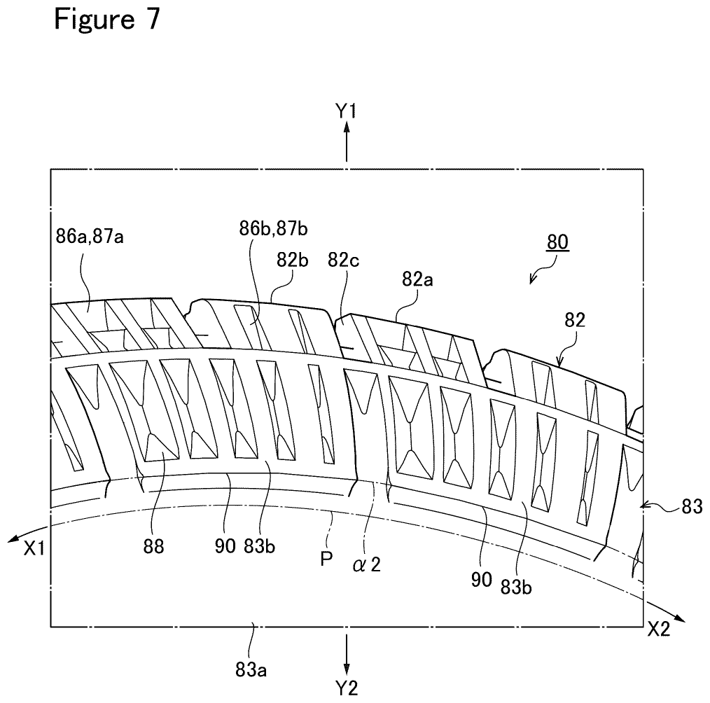

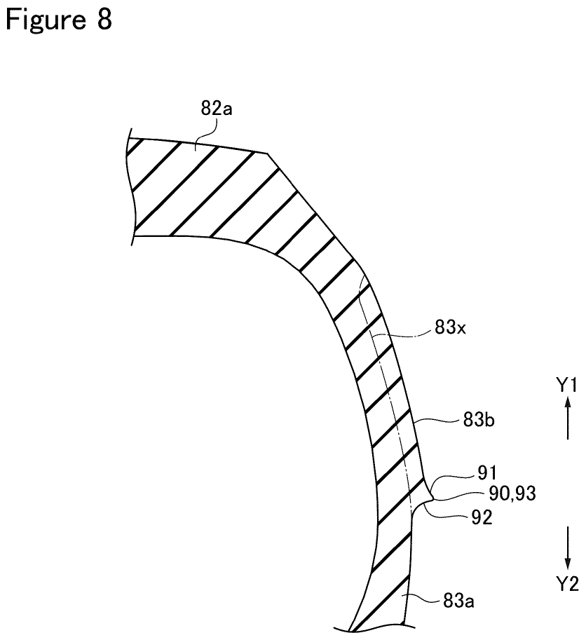

Hereinafter, another example of the embodiment will be described with reference to FIGS. 5 to 8. Note that in the following, differences from the first embodiment will be mainly described, and the above description will be used also for common or similar components. FIG. 5 is an enlarged perspective view of part of the side surface of a pneumatic tire 50 of a second embodiment, and FIG. 6 is a sectional view of a side block 53b of the pneumatic tire 50 and its vicinity. FIG. 7 is an enlarged perspective view of part of the side surface of a pneumatic tire 80 of a third embodiment, and FIG. 8 is a sectional view of a side block 83b and its vicinity of the pneumatic tire 80.

As shown in FIGS. 5 to 8, the pneumatic tires 50, 80 respectively have sidewalls 53, 83 that are respectively formed with the side blocks 53b, 83b. The pneumatic tires 50, 80 have something in common with the pneumatic tire 1 in that protrusions 70, 90 protruding outward in the tire axial direction are respectively formed at the inner ends of the side blocks 53b, 83b in the tire radial direction (Y2 direction ends). Furthermore, the pneumatic tires 50, 80 are similar to the pneumatic tire 1 in that they respectively have treads 52, 82 each including a plurality of blocks such as shoulder blocks.

The tread 52 of the pneumatic tire 50 has shoulder blocks 52a, 52b arranged alternately in the tire circumferential direction, and grooves 52c each separating the two blocks. Recesses 57a, 57b are respectively formed in side surfaces 56a, 56b of the shoulder blocks 52a, 52b. Each recess 57b of the shoulder block 52b is formed in a wide area of the side surface 56b over the entire length of the side surface 56b in the tire radial direction, and is larger and deeper than the recess 57a of the shoulder block 52a. Each recess 57a is formed long in the tire circumferential direction on the Y2 direction side of the side surface 56b.

The tread 82 of the pneumatic tire 80 has shoulder blocks 82a, 82b arranged alternately in the tire circumferential direction, and a groove 82c separating the two blocks. Recesses 87a, 87b are respectively formed in the side surfaces 86a, 86b of the shoulder blocks 82a, 82b. Each recess 87a has a shape that is divided into two in the tire radial direction, and two such recesses 87a are formed side by side in the tire circumferential direction on the side surface 86a of the shoulder block 82a. Two elongated recesses 87b extending in the tire radial direction are formed side by side in the tire circumferential direction on each side surface 86b of the shoulder block 82b. In both the recesses 87a, 87b, each recess on the X1 direction side is formed larger than the recess on the X2 direction side.

In buttress regions of the pneumatic tires 50, 80, as in the case of the pneumatic tire 1, the recesses of the shoulder blocks and grooves 52c, 82c form unevenness in the tire circumferential direction. The unevenness, together with the side blocks 53b, 83b, improves side traction performance on muddy ground, on sandy ground, or on snowy roads.

The protrusions 70, 90 of the pneumatic tires 50, 80 are respectively formed on the tread 52, 82 sides with respect to the maximum width positions P of the tires. The heights of the protrusions 70, 90 are between 1.1 and 3.0 times the respective heights of the portions highest in the side blocks 53b, 83b other than the protrusions, and the preferred height range is the same as that of each protrusion 30 of the first embodiment. The positions of the protrusions 70, 90 with respect to the maximum width positions P of the tires are each similar to those of the protrusion 30, and for example, the extremities 73, 93 of the protrusions 70, 90 are each located within a length range equivalent to 5% of the tire cross-sectional height H, in the Y1 direction, from the maximum width position P of the tire.

The plurality of protrusions 70 are formed on the circumference of the same circle α1 in the tire circumferential direction. The total length of the protrusions 70 in the tire circumferential direction is preferably 50% or more of the circumferential length of the circle α1. Likewise, the plurality of protrusions 90 are formed on the circumference of the same circle α2 in the tire circumferential direction. The total length of the protrusions 90 in the tire circumferential direction is preferably 50% or more of the circumferential length of the circle α2. As will be described in detail later, the protrusions 70, 90 each have a longer length in the tire circumferential direction than the protrusions 30 of the first embodiment.

Each protrusion 70 includes a first inclined surface 71 formed between the surface of the side block 53b and the extremity 73, and a second inclined surface 72 formed between the profile surface 53a of the sidewall 53 and the extremity 73. Compared to the second inclined surface 72, the first inclined surface 71 is gentler, and has a smaller inclination angle with respect to the profile surface 53x in the average value and in the maximum value. Likewise, in the protrusion 90, the first inclined surface 91 is gentler than the second inclined surface 92. This is likely to provide an airflow along the surfaces of the side blocks 53b, 83b, and causes more noticeable effect of reducing air resistance

As shown in FIG. 5, the side block 53b of the pneumatic tire 50 is a block that is continuous in the tire circumferential direction, and has a plurality of recesses 61, 62, and 63. In addition, the Y2 direction end of the side block 53b is formed with recesses 60 at predetermined intervals in the tire circumferential direction. The predetermined intervals may be constant, or may be a variable pitch in which the intervals between the blocks are slightly different in units of a predetermined number of blocks. In this embodiment, a pattern is repeated in the tire circumferential direction, the pattern having one recess 61, one recess 62, one recess 63, one shoulder block 52a, and one shoulder block 52b arranged between the two recesses 60.

On the Y1 direction side, the side block 53b has recesses 62, 63 formed alternately in the tire circumferential direction. The recesses 61 are formed on the Y2 direction side of the side block 53b so as to overlap with the recesses 62, 63 in the tire radial direction. The recesses 61, 62, 63 are all long in the tire circumferential direction, and are formed to a depth such that, for example, the bottom of the recess is equal to or higher than the profile surface 53a. Each recess 60 is shaped like a cutout at the Y2 direction end of the side block 53b in a side view. The recesses 60 and the recesses 61 are arranged alternately in the tire circumferential direction. The Y2 direction end of the side block 53b has a shape such that the recesses 60 extend into the side block 53b in the Y1 direction. Inside each recess 60, a raised portion 64 is formed that protrudes slightly from the profile surface 53a toward the outside in the tire axial direction and has a substantially V-shape in a side view.

The protrusions 70 formed at the Y2 direction end of the side block 53b are separated from each other in the tire circumferential direction by the recesses 60. The protrusions 70 are formed on the circumference of the circle α1 over the entire length of the portion other than the recesses 60. The length of each protrusion 70 in the tire circumferential direction is longer than the length of each recess 60 in the tire circumferential direction. As a result, the total length of the protrusions 70 in the tire circumferential direction is more than 50% of the circumferential length of the circle α1, for example, 55% or more and 75% or less of the circumferential length of the circle α1.

As shown in FIG. 7, the side blocks 83b of the pneumatic tire 80 are similar to the side blocks 3b of the first embodiment in that they are arranged at predetermined intervals in the tire circumferential direction. The predetermined intervals may be constant, or may be a variable pitch in which the intervals between the blocks are slightly different in units of a predetermined number of blocks. On the other hand, shapes of the side block 83b are significantly different from those of the side blocks 3b, and each interval between the side blocks 83b is smaller than that of the side blocks 3b.

Each side block 83b is formed with a plurality of recesses 88 that is rectangular in a side view and extends in the tire radial direction. The recess 88 gradually decreases in size from the X1 direction toward the X2 direction in the side block 83b. For example, the recess 88 located furthest in the X1 direction has a size that is two to ten times larger than the recess 88 located furthest in the X2 direction. In this embodiment, six recesses 88 of sizes that are different to each other are lined up in the tire circumferential direction. The interval between the side blocks 83b may be the same as or smaller than the tire circumferential length of the largest recess 88.

The protrusion 90 is formed along the entire length of the Y2 direction end of each side block 83b. The length of the protrusion 90 in the tire circumferential direction is longer than the interval between the side blocks 83b, and the total length of the protrusions 90 in the tire circumferential direction exceeds 50% of the circumferential length of the circle α2. The total length of the protrusions 90 in the tire circumferential direction is, for example, 75% to 95% of the circumferential length of the circle α2.

Also in the pneumatic tires 50, 80, the function of the protrusions 70, 90 can create an air flow along the surface of the sidewalls 53, 83, effectively reducing air resistance.

### REFERENCE SIGNS LIST

1 pneumatic tire, 2 tread, 2a, 2b shoulder block, 2c, 2d groove, 3 sidewall, 3a, 3x profile surface, 3b side block, 4 bead, 5 side rib, 6a, 6b side surface, 10 first side block, 11 projection, 12 inclined surface, 15 boundary, 20 second side block, 21 first region, 22 second region, 23 third region, 30 protrusion, 31 first inclined surface, 32 second inclined surface, 33 extremity, P tire maximum width position

1. A pneumatic tire comprising:
a tread; and
a sidewall, wherein
the sidewall includes at least one side block, and
at least one protrusion is formed at an inner end of the side block in a tire radial direction, the protrusion protruding outward in a tire axial direction.

2. The pneumatic tire according to claim 1, wherein a height of the protrusion is between 1.1 and 3.0 times a height of a highest portion of the side block other than the protrusion.

3. The pneumatic tire according to claim 1, wherein
the at least one side block comprises a plurality of side blocks, and the at least one protrusion comprises a plurality of protrusions,
the protrusions are formed on a circumference of a circle α in a tire circumferential direction, and
a total length of the protrusions in the tire circumferential direction is 30% or more of a circumferential length of the circle α.

4. The pneumatic tire according to claim 1, wherein the protrusion is formed within a length range from a tire maximum width position, the length range being equivalent to 20% of a tire cross-sectional height.

5. The pneumatic tire according to claim 4, wherein the protrusion is formed on an outer side in the tire radial direction relative to the tire maximum width position.

6. The pneumatic tire according to claim 1, wherein
the protrusion includes: a first inclined surface formed between a surface of the side block and a protrusion extremity; and a second inclined surface formed between a profile surface of the sidewall and the protrusion extremity, and
the first inclined surface has a smaller inclination angle with respect to the profile surface than the second inclined surface.

7. The pneumatic tire according to claim 1, wherein
the side block is an integrated block in which a first side block and a second side block are connected, the first side block and the second side block differing in height from each other, and
the protrusion is formed to have substantially the same height in the first side block and the second side block.

8. The pneumatic tire according to claim 7, wherein
the first side block has a shape in which a portion that is located on an inner side of the first side block in a tire radial direction projects in an opposite direction of the second side block, and
at a block end of the projection, an inclined surface is formed that is gentler than another block end.
